(19) United States
(12) Patent Application Publication
(10) Pub. No.: US 2011/0058176 A1
(43) Pub. Date: Mar. 10, 2011

(54) SPECTROMETERS UTILIZING MID INFRARED ULTRA BROADBAND HIGH BRIGHTNESS LIGHT SOURCES

(75) Inventors: Christian Pflugl, Cambridge, MA (US); Benjamin G. Lee, Cambridge, MA (US); Laurent Diehl, Cambridge, MA (US); Mikhail A. Belkin, Somerville, MA (US); Federico Capasso, Cambridge, MA (US); Thomas J. Tague, JR., Richmond, NH (US)

(73) Assignees: Bruker Optics, Inc., Billerica, MA (US); Presidents and Fellows of Harvard College, Cambridge, MA (US)

(21) Appl. No.: 12/263,948

(22) Filed: Nov. 3, 2008

(51) Int. Cl. G01J 3/45; G01J 5/02

(52) U.S. Cl. 356/451; 250/339.06

(57) ABSTRACT

A mid infrared spectrometer comprises a high brightness broadband source that generates an output with a broad spectral range in the order of hundreds of wave numbers, a wavelength dispersive element and a detector. In one embodiment, the source comprises an array of semiconductor laser devices operating simultaneously. Each device emits light at wavelength different from the wavelengths emitted by the other devices in the array and the devices are arranged so that the combined output continuously covers the broad spectral range. In another embodiment, each of the lasers in the array is a quantum cascade laser device. In still another embodiment, the quantum cascade laser devices in the array are operated in the regime of Risken-Nummedal-Graham-Haken (RNGH) instabilities. In yet another embodiment, each of the lasers in the array is a mode-locked quantum cascade laser device.

### GOVERNMENT RIGHTS

This invention was made with government support under HR0011-04-1-0032 awarded by the U.S. Department of Defense. The government has certain rights in the invention.

### BACKGROUND

Infrared spectroscopy is a material analysis technique that is based on the fact that molecules have specific vibrational modes or resonant frequencies at which they rotate or vibrate corresponding to discrete energy levels. These resonant frequencies are determined by the shape of the molecular potential energy surfaces, by the masses of the atoms and by the associated vibrational coupling between the molecules. An infrared spectrum of a material can be generated from a beam of infrared light generated by a light source with a known wavelength by either passing the light through the material or reflecting the light off of the material and measuring the energy in the transmitted or reflected light in order to determine how much energy was absorbed at that wavelength. The wavelength of the infrared light is then varied by using a monochromatic beam, which changes in wavelength over time, or by using a Fourier transform instrument to measure all wavelengths at once. From these measurements, a transmittance or absorbance spectrum can be produced, showing the infrared wavelengths and the amounts that are absorbed by the sample. An analysis of this absorption spectrum reveals details about the molecular structure of the material.

The spectral range of the infrared spectrum produced by the aforementioned technique depends on the spectral range of the infrared light source. Frequently, it is desirable to cover a large spectral range in the infrared spectrum. This may occur if the material sample under analysis is comprised of a large number of compounds or if the material sample is, in fact, an array of discrete samples together having absorption characteristics over a broad infrared spectrum. Of particular interest are wavelengths between 8.7 and 9.4 microns. These wavelengths are in the so-called “molecular fingerprint region” where most molecules have vibrational absorption features which uniquely identify them.

Mid-infrared (generally considered to be wavelengths of 3 to 15 μm) spectroscopy methods usually cover a large spectral range by utilizing a low brightness broadband light source and a wavelength dispersive element, such as an interferometer (for example, a Fourier transform infrared spectrometer). These techniques permit spectrums to be generated with spectral ranges in the order of hundreds to thousands of wave numbers, but the low brightness of the source reduces the signal to noise ratio of the output spectrum.

Accordingly, devices have been developed utilizing lasers with a broad bandwidth and high optical power, such as Fabry-Perot quantum cascade lasers, Fabry-Perot diode lasers or lead salt lasers in conjunction with a wavelength dispersive element, such as a Fourier transform spectrometer. An example of such a device is disclosed in U.S. Patent Publication No. 2007/0064230 A1. The light sources in the disclosed devices have high brightness and increase the available spectral range to a few tens of wave numbers. However, the spectral range that can be generated with such devices is still much less than the spectral range that can be generated with true broadband light sources. Specifically, these devices cannot cover the entire “fingerprint” region that is of particular interest. Therefore, a need still exists for a light source that overcomes the above-mentioned limitations and that can achieve an ultra broadband spectral output with high brightness.

### SUMMARY

In accordance with the principles of the present invention, a mid infrared spectrometer comprises a high brightness broadband source that generates an output with a broad spectral range in the order of hundreds of wave numbers, a wavelength dispersive element and a detector. In one embodiment, the source comprises an array of semiconductor laser devices operating simultaneously. Each device emits light in a wavelength range different from the wavelength ranges emitted by the other devices in the array and the devices are arranged so that the combined output continuously covers the broad spectral range.

In another embodiment, each of the lasers in the array is a quantum cascade laser device.

In still another embodiment, the quantum cascade laser devices in the array are operated in the regime of Risken-Nummedal-Graham-Haken (RNGH) instabilities.

In yet another embodiment, each of the lasers in the array is a mode-locked quantum cascade laser device.

### BRIEF DESCRIPTION OF THE DRAWINGS

FIG. 1 is a plan view of a laser array consisting of 32 lasers fabricated on a single semiconductor chip.

FIG. 2 is an enlarged view of the edge of the laser array 100 of FIG. 1 showing the individual lasers.

FIG. 3A is a band gap diagram of a convention semiconductor diode laser illustrating the generation of a photon by an electron-hole combination.

FIG. 3B is a quantum well diagram of a conventional quantum cascade laser illustrating photons generated by successive electron-hole combinations.

FIG. 4A is a schematic diagram of a laser waveguide structure into which a weak grating has been etched as a wavelength dispersive device to compensate for gain irregularities.

FIG. 4B is a schematic diagram of a laser waveguide structure on which a wavelength dependent facet coating has been placed as a wavelength dispersive device to compensate for gain irregularities.

FIG. 4C is a schematic diagram of a laser waveguide structure which uses an external cavity as a wavelength dispersive device to compensate for gain irregularities.

FIG. 5 is a graph illustrating optical power versus wave number of a quantum cascade laser operating in the regime of Risken-Nummedal-Graham-Haken (RNGH) instabilities.

FIG. 6A shows an illustrative method for focusing the light output of the laser array using a lens.

FIG. 6B shows an illustrative method for focusing the light output of the laser array by positioning the lasers.

FIG. 7 is a block schematic diagram showing an ultra broadband light source constructed in accordance with the principles of the invention incorporated into an IR spectrometer using an interferometer as the wavelength dispersive element.

FIG. 8 is a block schematic diagram showing an ultra broadband light source constructed in accordance with the principles of the invention incorporated into an IR spectrometer using a grating as the wavelength dispersive element.

FIG. 9 is a chart illustrating the wavelength output of each laser in a single mode laser array.

FIG. 10 is a block schematic diagram of the electronics used to drive the pulsed laser array.

FIG. 11 is a block schematic diagram showing a pulsed laser array constructed in accordance with the principles of the invention incorporated into an IR spectrometer.

FIG. 12 is a graph showing absorption measurements through 200 μm water with a globar source and a single Fabry-Perot quantum cascade laser.

### DETAILED DESCRIPTION

In accordance with the principles of the invention, a light source having a broad spectral output is formed by an array of lasers in which the lasers operate simultaneously and each laser is tuned to a different wavelength range. In one embodiment, the lasers in the array are semiconductor lasers and can include, but are not limited to, Fabry-Perot diode lasers, Fabry-Perot lead salt lasers and Fabry-Perot quantum cascade lasers. These lasers may have distributed feedback and can also be processed into low-power consumption micro-cavity lasers, second-order distributed feedback surface emitting structures and vertically-cavity-surface-emitting waveguide structures.

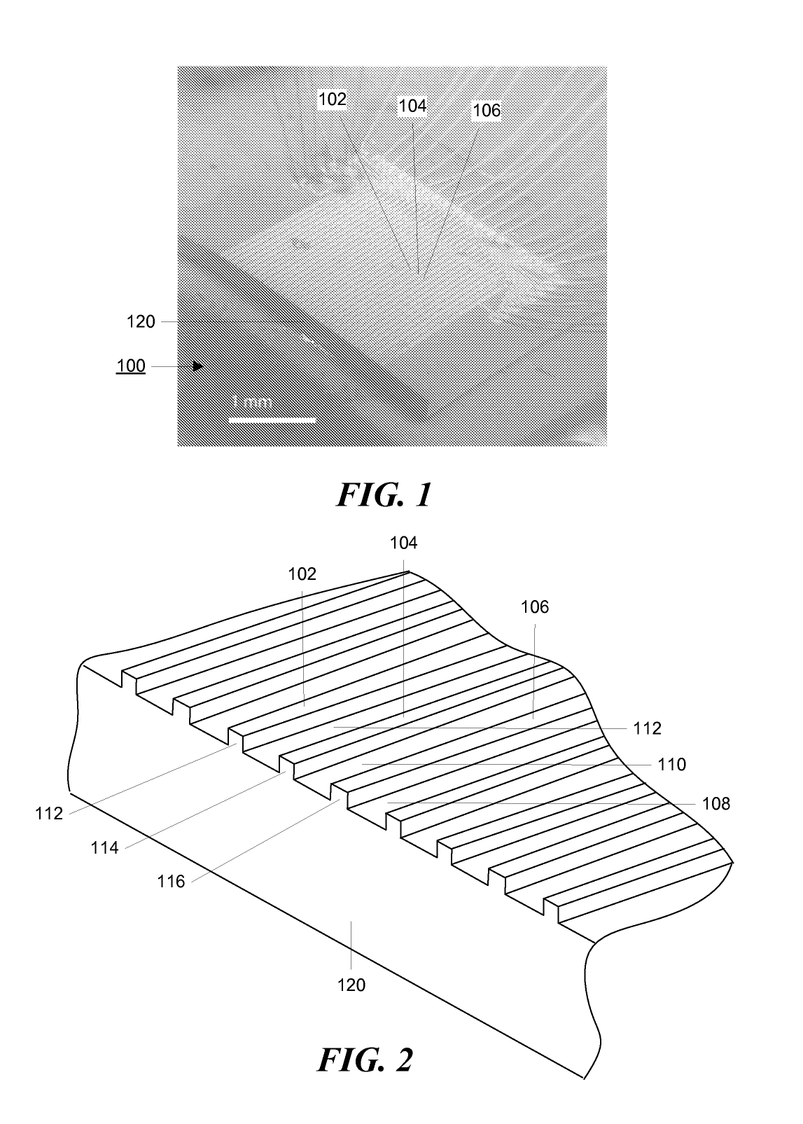

An example of such an array 100 is shown in FIGS. 1 and 2 which show plan and edge views of a single semiconductor chip 120 on which 32 lasers have been fabricated. In this example, the laser active medium is grown by a commercial reactor used for the mass production of semiconductor lasers. The laser active material can be fabricated into a set of lasers by etching parallel trenches, for example, trenches 108, 110 and 112 (FIG. 2) in the quantum cascade gain material to create isolated ridges, for example ridges 102, 104 and 106 or by using a conventional buried heterostructure (not shown in FIGS. 1 and 2). A laser cavity is then formed by cleaving the ends of the device to form Fabry-Perot cavities from each ridge. For example, in FIG. 2, laser light is emitted from the cleaved ends 112, 114 and 116 of ridges 102, 104 and 106. Also shown in FIG. 1 are the electrical leads and bonding pads. The finished semiconductor chip is approximately 4×5-mm.

Several Fabry-Perot lasers formed in this manner with different ridge widths or lengths working in the same wavelength range can be used to increase the spectral coverage in a certain wavelength range. Other techniques for increasing the wavelength range include altering the effective refractive index to change the spectral position of the longitudinal modes. Alternatively, one or both of the waveguide end facets may have an anti-reflection coating that defeats the optical cavity action of the cleaved facets. Mirrors are then arranged in a configuration external to the device to create an external optical cavity. This type of laser can be tuned to a much broader spectral range by including devices, such as gratings in the external cavity, but such devices are complex to build, requiring careful alignment and high-quality antireflection coatings and a piezoelectric controller to vary the cavity length.

For many applications the spacing between two Fabry-Perot modes (typically <1 cm⁻¹) is sufficient and thus a source consisting of an array of Fabry-Perot lasers operating in different wavelength regions can be used to cover a broad spectral range. If a better resolution is necessary, the Fabry-Perot peaks can be temperature tuned to cover continuously the whole wavelength range. This can be accomplished by heating the heat sink to which the devices are attached or by controlling the operating current of the devices.

In another embodiment of the invention, quantum cascade lasers are used as the laser devices in the laser array. A quantum cascade laser is a semiconductor device that can operate at infrared and terahertz wavelengths and advantageously can generate at room temperature an output with wavelengths from 3 to 15 μm, in the “molecular absorption fingerprint” region of the spectrum that is very important for chemical sensing.

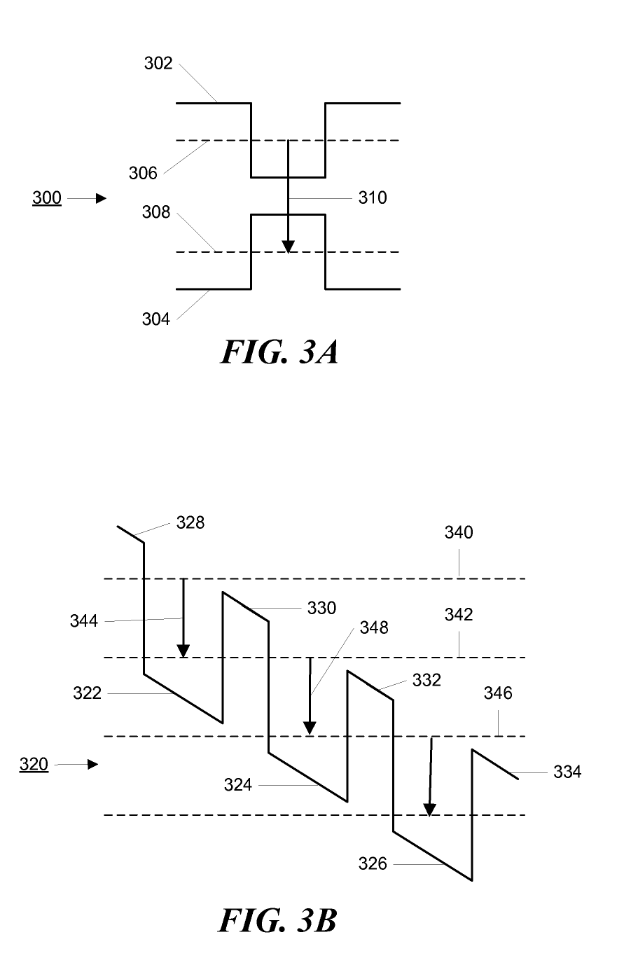

Quantum cascade lasers are similar to conventional diode lasers in external appearance and can be produced in the same semiconductor foundries that produce diode lasers for the telecommunications industry. However, the operation of quantum cascade lasers differs from the operation of diode lasers. In a diode laser, light is generated by the recombination of electrons and holes, and the wavelength of the emitted light is determined by the semiconductor band gap. This is shown in the band gap diagram 300 of FIG. 3A. Electrons in the conduction band 302 recombine with holes in the valence band 304. When an electron at level 306 in the conduction band 302 combines with a hole at level 308 in the valence band, the emitted photon has a wavelength determined by the band gap difference in the levels as indicated schematically by arrow 310.

In contrast, in a quantum cascade laser, the laser transition occurs between electron levels in the conduction band of a semiconductor superlattice as shown in the quantum level diagram 320 of FIG. 3B. A superlattice can be formed in a material by creating periodically alternating layers of several substances to form quantum wells, of which wells 322, 324 and 326 are shown separated by barriers, of which barriers 328, 330, 332 and 334 are shown. An electron at level 340 in well 322 can transition to level 342 thereby emitting a photon with a wavelength determined by the difference in energy levels as indicated by arrow 344. Then the electron can tunnel through the barrier 330 and transition to level 346 emitting another photon as indicated by arrow 348. This process is repeated causing a “cascade” of electrons thereby giving the device its name. By changing the thicknesses of the quantum wells and barriers in the superlattice, the energy levels can be changed to produce a laser transition at the desired wavelength. In a laser array, such as that shown in FIGS. 1 and 2, quantum cascade lasers can be fabricated and designed using state-of-the-art nanotechnology by controlling the size of nanometric thin quantum wells in the active region.

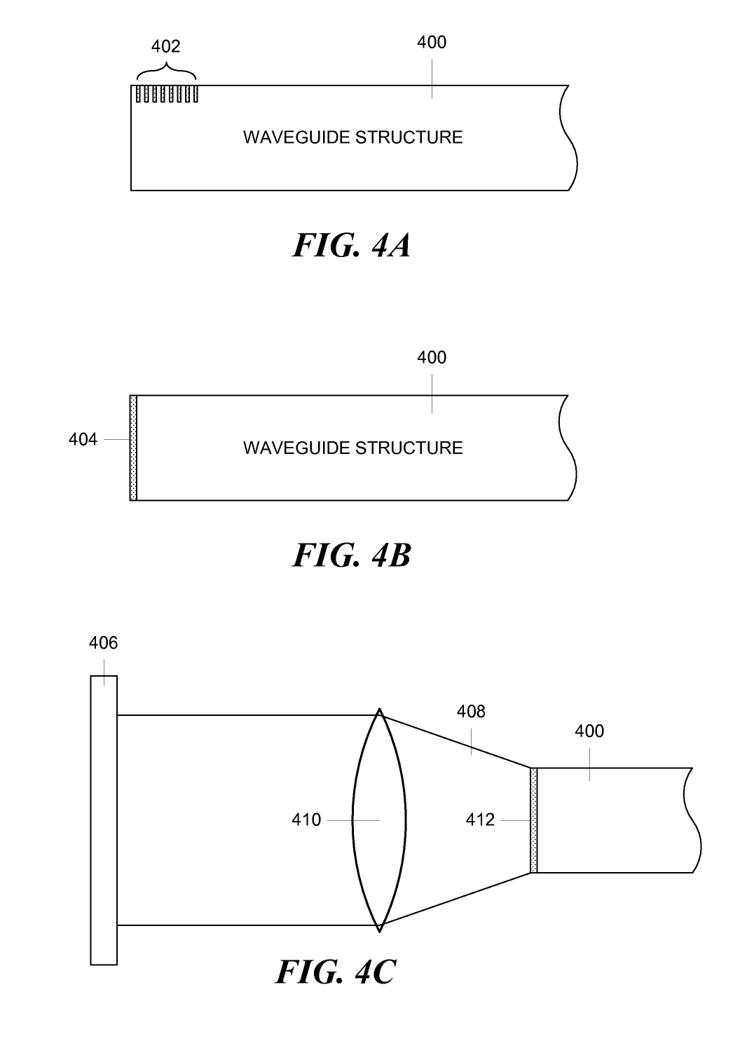

Fabry-Perot quantum cascade lasers operating in multimode configuration are capable of producing outputs at wavelengths anywhere between 3 and 24 μm with wavelength ranges in the order of 60 to 300 μm. Even larger wavelength ranges can be achieved with special designs, such as multi-stack quantum cascade lasers. However, it is a difficult task to obtain broadband lasing of a single Fabry-Perot quantum cascade laser, due to a number of effects, such as inhomogeneous gain spectrum and wavelength dependent waveguide losses. To compensate for these effects, a wavelength dispersive element can be included in the waveguide as schematically illustrated in FIGS. 4A-4C. Such as wavelength dispersive element can be a weak grating 402 etched into the waveguide 400 as shown in FIG. 4A. Alternatively, the wavelength dispersive element can be a wavelength dependent facet coating 404 at the end of the waveguide structure 400 as shown in FIG. 4B. Further, the wavelength dispersive element could be an end mirror 406 in an external cavity configuration in which the laser beam 408 is expanded by a lens 410. In this case, an anti-reflective coating 412 is applied to the end facet of the waveguide structure 400.

In accordance with another embodiment of the invention, quantum cascade laser devices used for the broadband laser source array can be operated in the regime of Risken-Nummedal-Graham-Haken (RNGH) instabilities to increase the wavelength range of a single device and thereby allow the laser array to cover a broader spectral range. RNGH instabilities are produced by increasing the pumping current of a quantum cascade laser as discussed, for example, in detail in an article entitled, “Coherent Instabilities in a Semiconductor Laser with Fast Gain Recovery”, C. Y. Wang, L. Diehl, A. Gordon, C. Jirauschek, F. X. Kartner, A. Belyanin, D. Bour, S. Corzine, G. Hofler, M. Troccoli, J. Faist, and F. Capasso, Physical Review A Rapid Communications 75, 31802 (2007) which article is hereby incorporated herein by reference in its entirety.

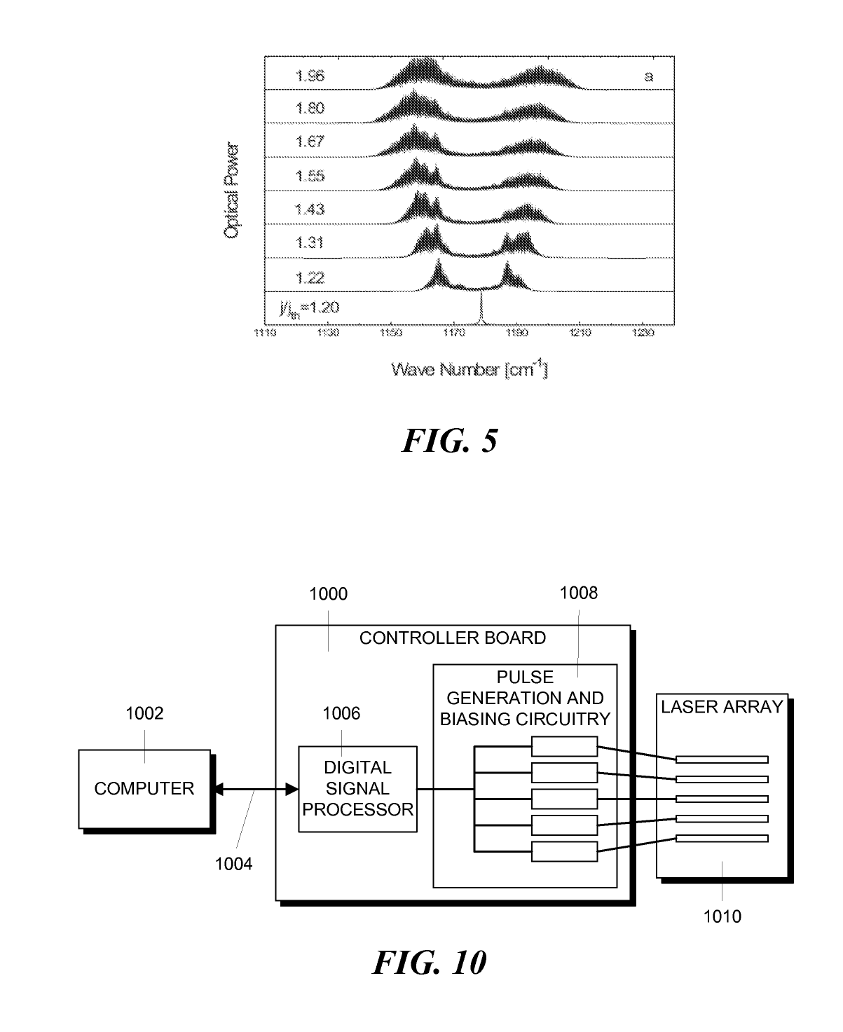

FIG. 5 taken from the aforementioned article, illustrates optical output spectra produced by a 3 μm wide buried heterostructure quantum cascade laser emitting at 8.38 μm. The horizontal axis indicates the output spectrum produced by the device in wave numbers and the vertical axis is the pumping ratio (j/jₜₕ) above a threshold jₜₕ obtained in continuous wave operation at 300° K. For 1<j/jₜₕ<1.2 the spectra are identical to the spectrum produced at j/jₜₕ=1.2 and have been omitted from the figure. From FIG. 5 it can be seen that wavelength ranges on the order of 70 cm⁻¹ are readily obtainable from a single device.

In still another embodiment, the spectral width of a single quantum cascade laser device can also be increased by using mode-locking. Passive mode-locking requires a mechanism, such as a fast saturable absorber, to induce a fixed phase relationship between the longitudinal modes of the resonant laser cavity. If the condition for the phase relation is met for at least a few optical modes, the output of the laser resembles a regular train of short pulses separated by a time duration equal to the time duration that light requires to make a round-trip in the laser cavity. The temporal width of the pulses is inversely proportional to the spectral width over which the phase difference between different laser cavity modes can be kept constant. A mode-locking mechanism that leads to the formation of short pulses can therefore force the optical spectrum of a laser to significantly broaden. Mode-locking can hence be used to increase the spectral width of quantum cascade lasers.

Other mechanisms that can induce phase locking of laser modes include the direct modulation of the current injected in a quantum cascade laser or a portion of a quantum cascade laser at the cavity round-trip frequency, as described for example in the article entitled “Monolithic active mode locking of quantum cascade lasers” by R. Paiella, F. Capasso, C. Gmachl, H. Y. Hwang, D. L. Sivco, A. L. Hutchinson and A. Y. Cho, Applied Physical Letters, 77, 169 (2000).

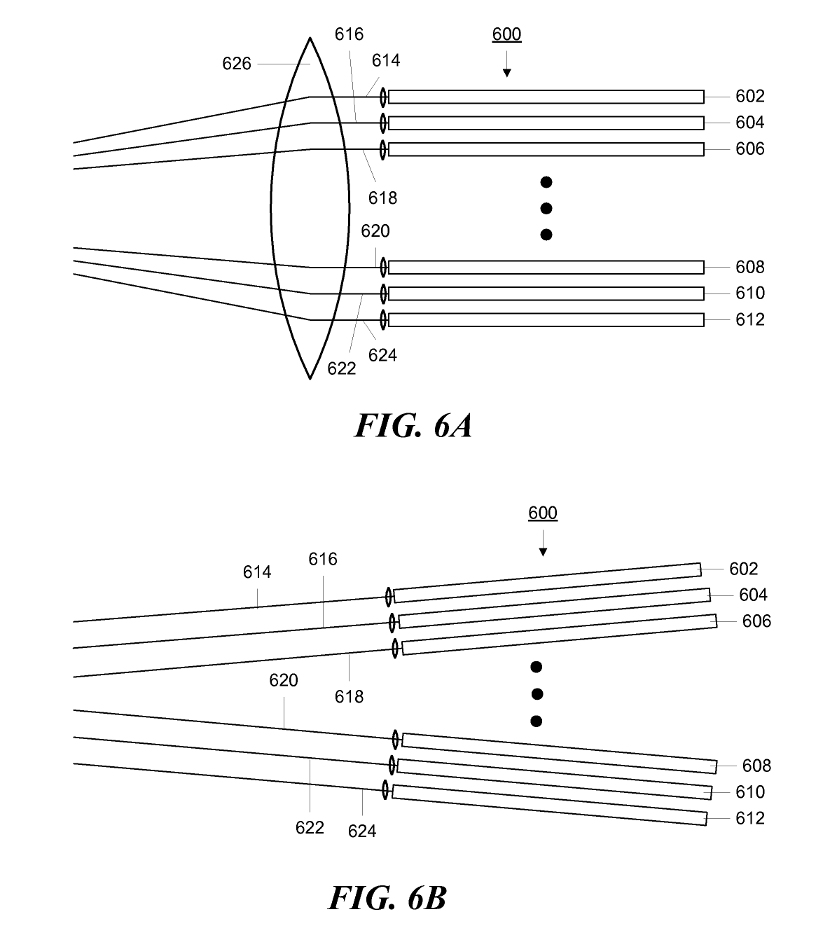

Several mechanisms can be used to focus the laser outputs of the laser array. Two illustrative alternatives are illustrated schematically in FIGS. 6A and 6B. Because the lasers have some degree of divergence, a collimation microlens can be placed in front of each laser in the array to achieve a high degree of collimated emissivity. These microlenses are illustrated in FIGS. 6A and 6B immediately to the left of each laser. In one alternative, the individual lasers in laser array 600 (of which lasers 602-612 are shown in FIG. 6A) are arranged in a parallel configuration and the lasers beams 614-624 are focused with a lens 626. In an alternative arrangement, the lens is omitted and the beams 614-624 of lasers 602-612 are focused by angling the laser waveguide structures.

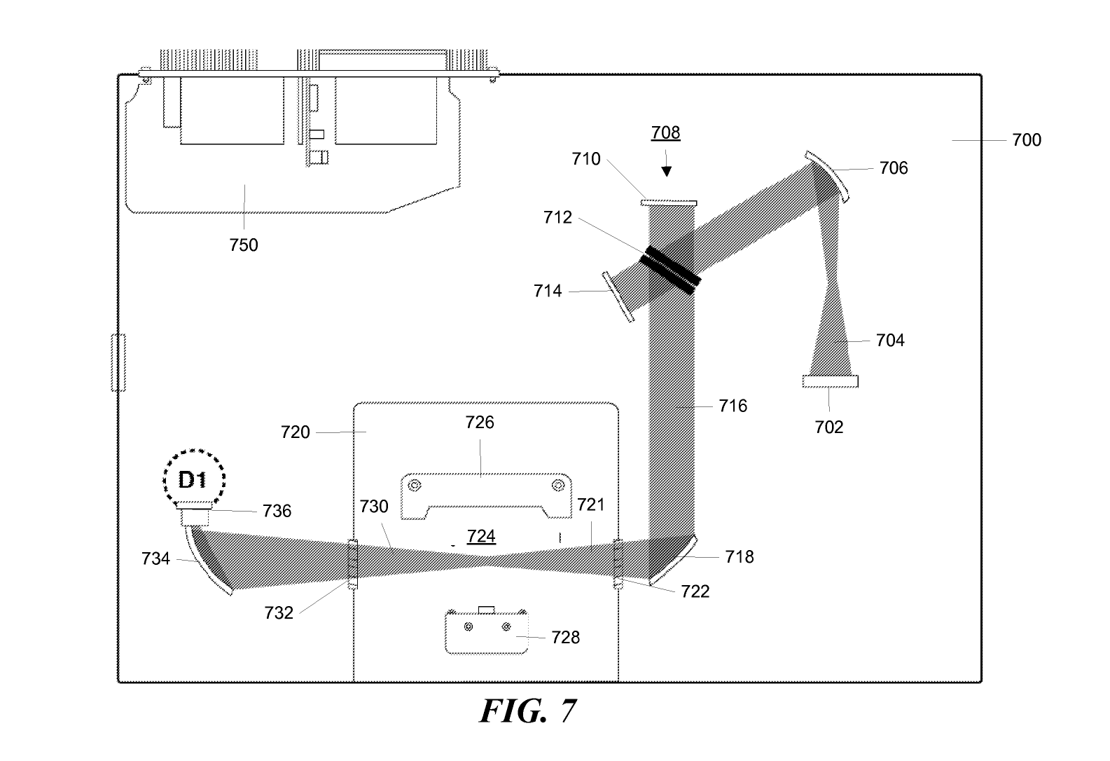

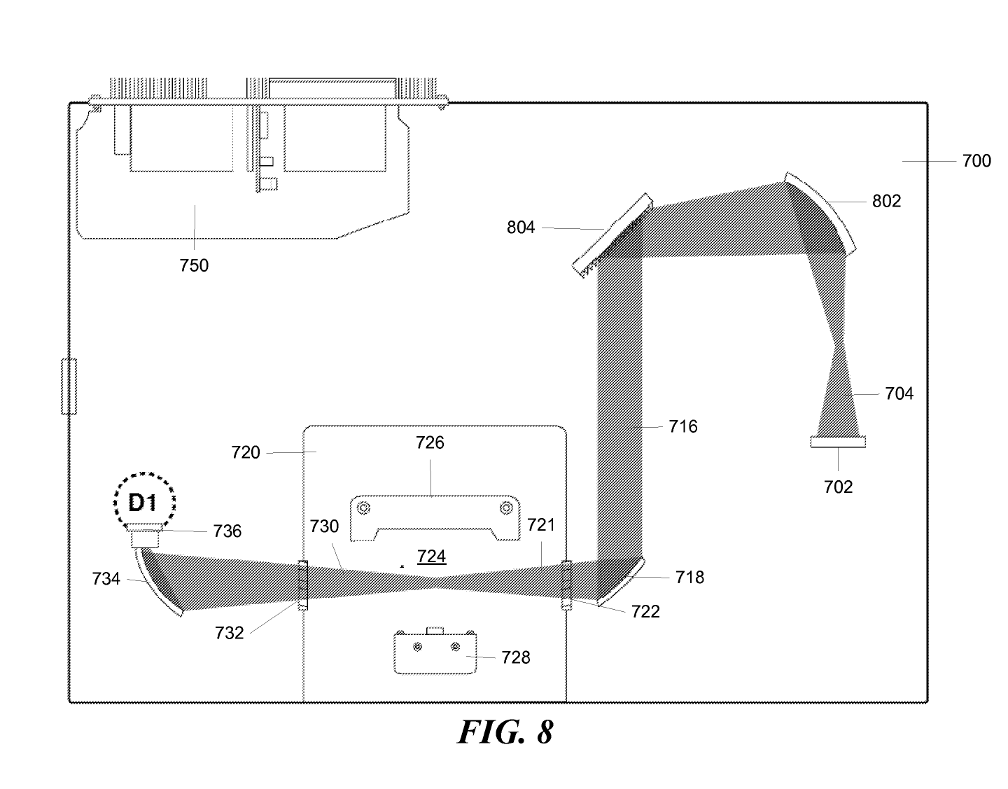

Such laser arrays can be used with a wavelength dispersive device in a mid infrared spectrometer. Such a spectrometer is illustrated in schematic form in FIGS. 7 and 8. FIG. 7 shows a spectrometer 700 where the wavelength dispersive device is an interferometer. The broadband source 702 generates a light beam 704 with a broad wavelength range. This beam is reflected from a mirror 706 to an interferometer 708 comprising a pair of mirrors 710 and 714 and a beam splitter 712. The resulting interferogram 716 is reflected from mirror 718 into the sample chamber 720. The beam 721 enters the chamber 720 via input window 722 and interacts with a sample in sample position 724 where a sample is held in position by sample holders 726 and 728. After interacting with the sample, the light beam 730 travels out of the sample chamber 720 via outlet window 732. The beam is reflected from mirror 734 to detector 736. Also schematically illustrated in FIG. 7 are electronics 750 which control and coordinate the operation of the spectrometer in a conventional fashion.

FIG. 8 shows a spectrometer 800 where the wavelength dispersive device is a grating. Components in FIG. 8 that correspond to those in FIG. 7 have been given the same numeral designations. Here the beam 704 generated by the broadband source 702 is reflected from the prism 802 onto a grating 804 which selects a particular wavelength. The selected wavelength then follows the same path as in FIG. 7.

The use of spectrally broad and bright laser sources in systems using wavelength dispersive elements (e.g. Fourier-transform infrared spectrometers (FTIRs)) for wavelength selection significantly increases the areas of applications. Because of the high brightness, absorption features of many optically dense media (liquids) can be investigated simultaneously that are not accessible with standard globar light sources used typically in FTIRs. Other applications are the multiplexed analysis of many species for defense related, pharmacological, and analytical applications (remote sensing).

In another arrangement, the individual quantum cascade lasers in the laser array can also be processed as distributed feedback lasers in order to insure that each laser operates in as single mode. A Fabry-Perot laser can be converted to a distributed feedback laser by forming a distributed Bragg reflector on top of the waveguide to prevent it from emitting at other than the desired wavelength and to force single mode operation. It is possible to tune the output wavelength of distributed feed back lasers by changing the temperature, but such tuning is only possible over a narrow tuning wavelength range on the order of 10 cm⁻¹.

In this case, a microcomputer individually operates and tunes each laser in the array in pulse mode in any desired sequence. This generates a broad and continuously tunable wavelength spectrum that can be used to detect a large number of chemical compounds without the use of an additional wavelength dispersive device in the spectrometer.

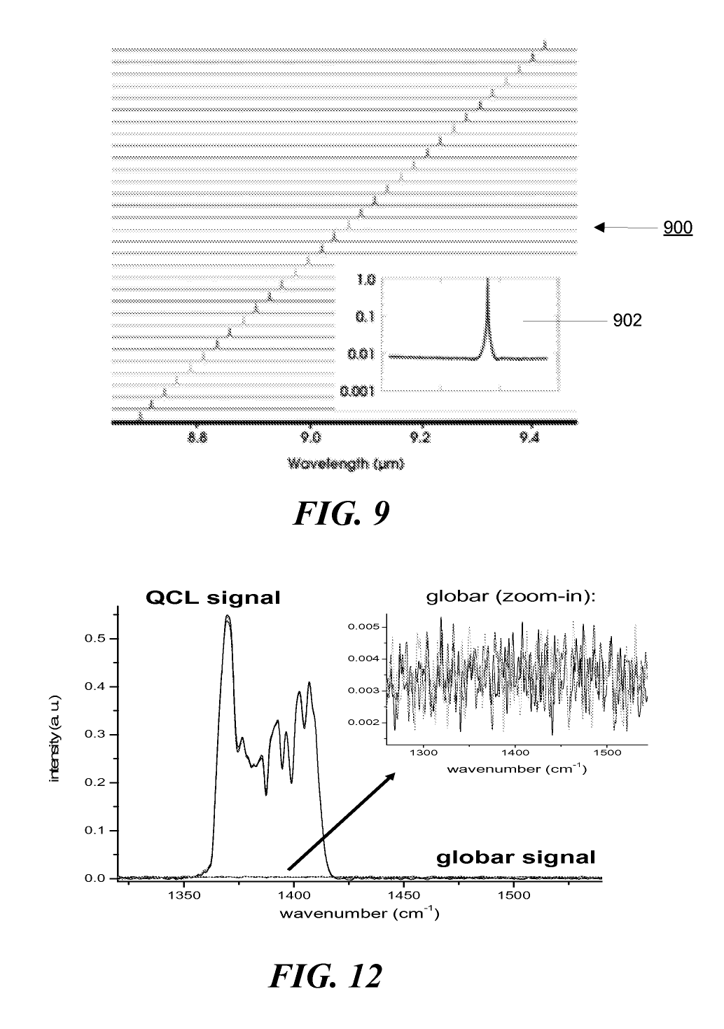

For example, in the laser array disclosed above, distributed feedback lasers can be fabricated by cladding layers of InP and InGaAs around the thick active region based on an InGaAs/AlInAs heterostructure that is lattice-matched to InP. An array of buried distributed feedback gratings are then fabricated in the material by removing the top InP cladding layer, by etching first-order Bragg gratings in the InGaAs layer next to the active region and by regrowing the InP cladding above the buried gratings. After further conventional processing steps, an array of distributed feedback lasers is produced on the chip. Each individual laser in the array is designed to emit at a different wavelength. In one illustrative example, the grating periods were 1.365 to 1.484 μm, which resulted in lasing wavelengths in the array of 8.73 to 9.43 μm with 22-nm spacing. These emission wavelengths are illustrated in FIG. 9 which shows the output spectra of the 32 single-mode distributed-feedback lasers in the array. The laser wavelengths are spaced 22 nm apart and span the range from 8.73 to 9.43 μm. The inset 902 shows the spectrum of a representative laser in the array on a log scale, revealing that unwanted side modes are suppressed by more than 20 dB.

In addition, the emission wavelength of each individual laser can be temperature-tuned in a small range so that it can cover the entire region between the emission wavelengths of its neighbors. Temperature tuning in a laser can be accomplished by heating it locally—sending a DC bias current through the laser—or by changing the temperature of the whole array—heating and cooling the system heat sink. For example, if the system heat sink is heated from 300 to 390° K, the emission wavelengths were tuned continuously, with each individual laser's output wavelength changing by approximately 50 nm over the full temperature range. Thus, with temperature tuning, the illustrative laser array can emit any wavelength in the range of 8.73 to 9.43 μm Thus, a single array can be used to target all the molecular absorption lines in that range for sensing.

In the illustrative example, the distributed feedback lasers in the array were bonded individually to a circuit board that was connected to a custom-designed electronics controller 1000 shown schematically in FIG. 10. The controller 1000 can power the lasers, tune their emission wavelengths and interface with a laptop/desktop computer 1002 via a USB serial bus 1004. The serial bus 1004 controls a digital signal processor 1006, which, in turn, controls individual pulse generation and biasing circuits 1008 for each laser in the array 1010. In this manner, all 32 lasers are individually connected to separate channels on the controller, allowing each laser to be addressed individually in order to adjust the laser frequency with temperature tuning and to fire the lasers with arbitrary timing.

The frequency resolution of the quantum cascade laser array is determined by the laser line widths, which can be on the order of approximately 0.1 nm in pulsed operation. This resolution is an order of magnitude higher than that provided by a standard “bench top” commercial FTIR spectrometer and is roughly comparable to the line width of gas absorption features at atmospheric pressure. With careful stabilization of the current source and the device temperature, a quantum cascade laser operating in the continuous-wave regime can achieve a line width smaller than 0.001 nm.

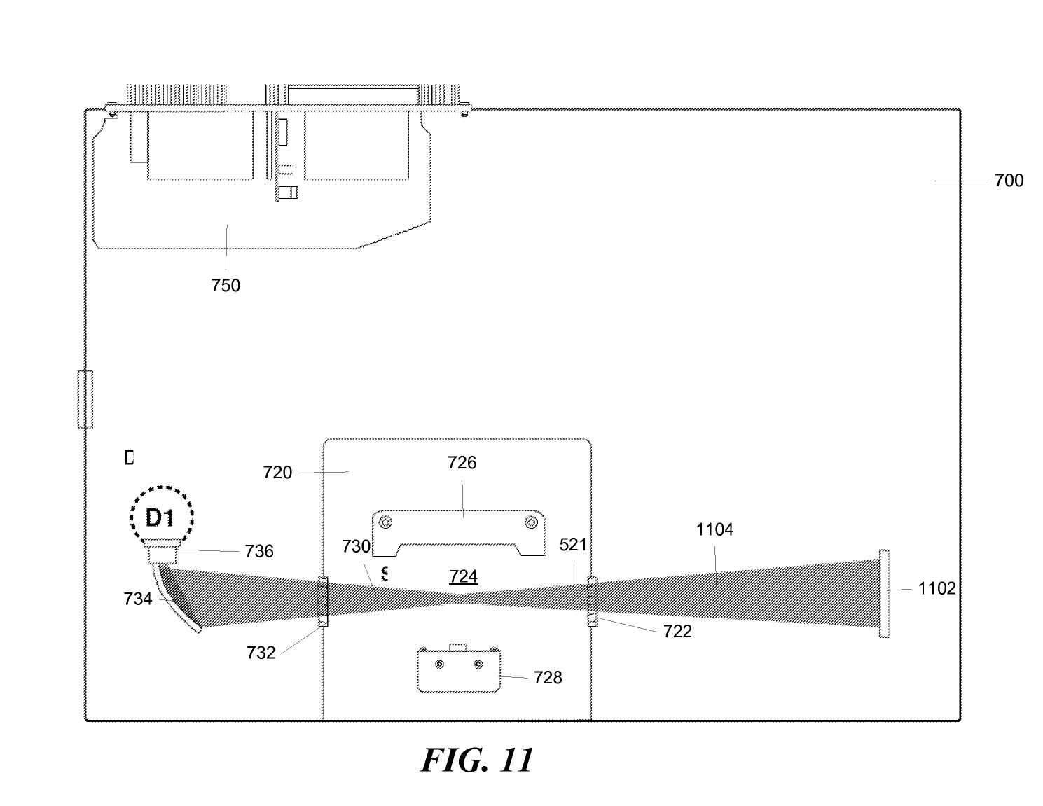

The use of such a laser array in a spectrometer is shown schematically in FIG. 11. Components illustrated in FIG. 11 that are the same as those in FIGS. 7 and 8 have been given the same numeral designations. Here the light beam 1104 generated by the laser array 1102 is directly applied to the sample chamber 720. Although the spectral bandwidth provided by a broadband quantum cascade laser array is smaller than that of an FTIR spectrometer, this limitation does not impede most sensing applications, since most of the important absorption lines occur in the 8 to 12 μm spectral range, and quantum cascade lasers with broadband gain can cover most of this range. In addition, the chemicals to be monitored usually are known, and a quantum cascade laser can be designed to have laser gain at the wavelengths where those chemicals absorb light. The much higher brightness of quantum cascade lasers as compared with the thermal sources (glow bars) used in FTIR spectrometers should lead to substantial improvements in sensitivity. This is shown in FIG. 12 which shows absorption measurements through 200 μm water using a FTIR spectrometer and a liquid nitrogen cooled MCT detector. Two different sources were used: a globar source and a single Fabry-Perot quantum cascade laser (bandwidth ˜60 cm⁻¹) operated in continuous mode at 283K on a thermoelectric cooler. No signal could be detector with the globar source, but a strong signal from the quantum cascade laser device was detected.

In terms of size and portability, there is no question that quantum cascade laser-based sensors would be more compact and portable than FTIR spectrometers. Because the lasers can be produced in the same foundries that produce diode lasers for the telecom industry, their cost potentially could drop to the levels of laser diodes. Thus, quantum cascade laser-based sensors could be quite inexpensive, particularly when compared with FTIR spectrometers, which contain sophisticated mechanical and optomechanical components.

While the invention has been shown and described with reference to a number of embodiments thereof, it will be recognized by those skilled in the art that various changes in form and detail may be made herein without departing from the spirit and scope of the invention as defined by the appended claims.

What is claimed is:

1. An infrared spectrometer comprising:
a broadband laser source having a plurality of lasers operating simultaneously, each laser generating an output with a wavelength different from the output wavelengths of the other lasers;
a wavelength dispersive element; and
a detector.

2. The infrared spectrometer of claim 1 wherein the wavelength dispersive element comprises a grating.

3. The infrared spectrometer of claim 1 wherein the wavelength dispersive element comprises an interferometer.

4. The infrared spectrometer of claim 1 wherein each of the plurality of lasers comprises a semiconductor laser.

5. The infrared spectrometer of claim 1 wherein each of the plurality of lasers comprises a quantum cascade laser operating in multi-mode.

6. The infrared spectrometer of claim 1 wherein each of the plurality of lasers comprises a quantum cascade laser operating in single-mode.

7. The infrared spectrometer of claim 1 wherein each of the plurality of lasers comprises a quantum cascade laser operating in the RNGH regime.

8. The infrared spectrometer of claim 1 wherein each of the plurality of lasers comprises a mode-locked quantum cascade laser.

9. The infrared spectrometer of claim 1 wherein the plurality of lasers comprises an array of semiconductor lasers fabricated on a single semiconductor chip.

10. The infrared spectrometer of claim 1 wherein each of the plurality of lasers comprises a wavelength dispersive device in order to compensate for gain irregularities.

11. A method for operating an infrared spectrometer having an infrared source, a wavelength dispersive element, and a detector, the method comprising providing as the infrared source a broadband laser source having a plurality of lasers operating simultaneously, each laser generating an output with a wavelength different from the output wavelengths of the other lasers.

12. The method of claim 11 further comprising providing a grating for the wavelength dispersive element.

13. The method of claim 11 further comprising providing an interferometer as the wavelength dispersive element.

14. The method of claim 11 further comprising providing a semiconductor laser for each of the plurality of lasers.

15. The method of claim 11 further comprising providing a quantum cascade laser operating in multi-mode for each of the plurality of lasers.

16. The method of claim 11 further comprising providing a quantum cascade laser operating in single-mode for each of the plurality of lasers.

17. The method of claim 11 further comprising providing a quantum cascade laser operating in the RNGH regime for each of the plurality of lasers.

18. The method of claim 11 further comprising providing a mode-locked quantum cascade laser for each of the plurality of lasers.

19. The method of claim 11 further comprising providing an array of semiconductor lasers fabricated on a single semiconductor chip for the plurality of lasers.

20. The method of claim 11 further comprising providing a wavelength dispersive device in each of the plurality of lasers in order to compensate for gain irregularities.

21. An infrared spectrometer comprising:
a quantum cascade laser source operating in the RNGH regime;
a wavelength dispersive element; and
a detector.
